(19) United States
(12) Patent Application Publication
(10) Pub. No.: US 2006/0134352 A1
(43) Pub. Date: Jun. 22, 2006

(54) Knockdown article foldably assembled from multiple sheets as linked by universal couplings

(76) Inventor: Nan-Jung Huang, Hsin-Chu (TW)

Correspondence Address: Nan-Jung Huang, P. O. Box 55-846, Taipei, 104, TW

(21) Appl. No.: 11/012,384

(22) Filed: Dec. 16, 2004

(51) Int. Cl. G09F 17/00; G09F 19/00; B31D 3/02

(52) U.S. Cl. 428/12; 428/8; 428/9; 428/7

(57) ABSTRACT

A knockdown article includes a plurality of sheets which are linked by a plurality of universal couplings, each coupling having at least two pins for respectively engaging two pin holes formed in two neighboring sheets to thereby link the two neighboring sheets; whereby upon completion of the linking of all sheets, a decorative article can be foldably assembled.

### BACKGROUND OF THE INVENTION

A conventional decorative article such as a Christmas tree or lamp shade is generally assembled by a plurality of sheet members. The sheet members are fastened with one another by any wellknown elements. Such decorative article is assembled as a fixed article to occupy an appreciable volume which may therefore increase shipping or handling cost. Also, it may cause inconvenience for storage and transportation.

The present inventor has found the drawbacks of the conventional decorative articles and invented the present invention of knockdown article.

### SUMMARY OF THE INVENTION

The object of the present invention is to provide a knockdown article including a plurality of sheets which are linked by a plurality of universal couplings, each coupling having at least two pins for respectively engaging two pin holes formed in two neighboring sheets to thereby link the two neighboring sheets; whereby upon completion of the linking of all sheets, a decorative article can be foldably assembled.

### BRIEF DESCRIPTION OF THE DRAWINGS

FIG. 1 is a perspective view of the present invention.

FIG. 2 shows a partitioning sheet in construction of the present invention.

FIG. 3 shows the partitioning sheet and the coupling before being fastened.

FIG. 4 shows the partitioning sheet to be coupled to a rear sheet of the present invention.

FIG. 5 shows the rear sheet fastened to the partitioning sheet following FIG. 4.

FIG. 6 is a perspective view for assembling the present invention following FIG. 5.

FIG. 7 is an illustration following the step as shown in FIG. 6.

FIG. 8 shows the article ready for completion following FIG. 7.

FIG. 9 is a perspective view of the couplings of the present invention.

FIG. 10 shows another preferred embodiment of the present invention.

FIG. 11 shows the step when assembling the present invention as shown in FIG. 10.

FIG. 12 shows further step for assembling the article following FIG. 11.

FIG. 13 shows the elements of the coupling for assembling the article as shown in FIG. 11.

FIG. 14 shows the coupling when assembled from FIG. 13.

FIG. 15 shows another example of the elements of the coupling as modified from FIG. 13.

FIG. 16 shows the coupling when assembled from FIG. 15.

FIG. 17 shows still another preferred embodiment of the present invention.

FIG. 18 shows the elements in construction of the article as shown in FIG. 17.

FIG. 19 shows the assembly of plural sheet members of the article of FIG. 17.

FIG. 20 shows a fastening ring for fastening the sheet members of the article of FIG. 17.

### DETAILED DESCRIPTION

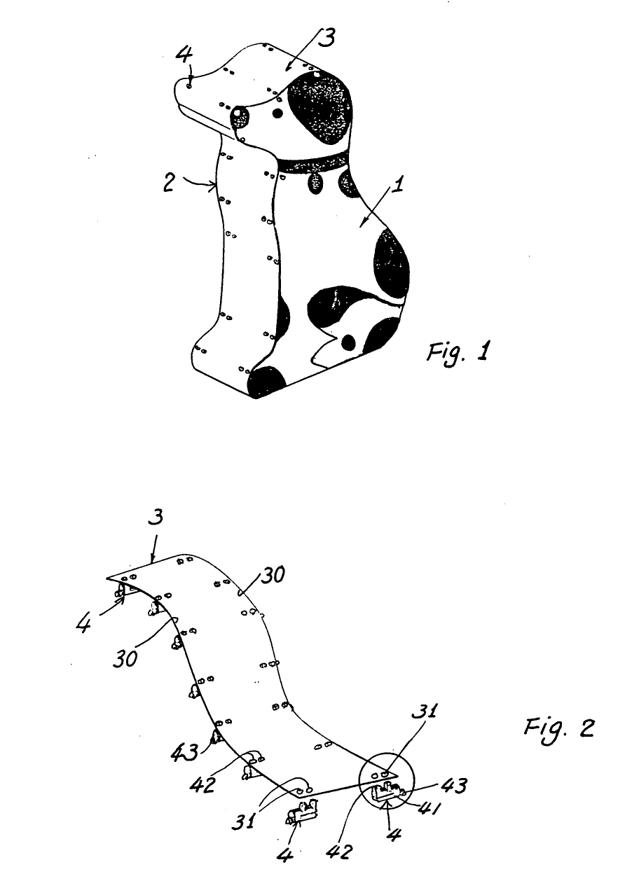

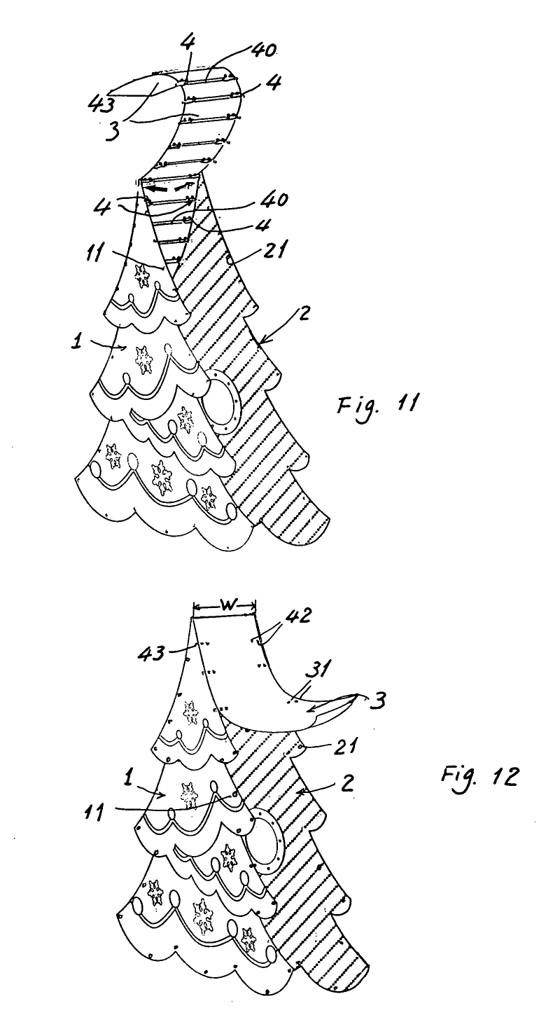

As shown in FIGS. 1˜9, a knockdown article such as a decorative article of dog is assembled by the steps as shown from FIG. 2˜FIG. 8 as linked, coupled or fastened by the couplings as shown in FIG. 9.

The decorative articles and couplings 4 are not limited to the embodiments as shown in the accompanying drawings of this application. They may be modified without departing from the spirit and scope of the present invention.

The dog-shaped decorative article as shown in FIG. 1 includes: a front sheet 1, a rear sheet 2 juxtatpositioned to the front sheet 1, and a partitioning sheet 3 spaced in between the front sheet 1 and the rear sheet 2; all the sheets 1, 2, 3 being detachably or foldably assembled by a plurality of couplings 4 especially as shown in FIG. 9.

The coupling 4 as shown in FIG. 9 includes: a bolt 41 defining a longitudinal axis X at its longitudinal center, two (or at least one) normal pins 42 protruding outwardly from the bolt 41 to be perpendicular to the longitudinal axis X, and a parallel pin 43 protruding sidewardly from the bolt 41 to be parallel to the longitudinal axis X of the bolt. The two normal pins 42 are projectively aligned to be parallel to the longitudinal axis X of the bolt 41.

Each pin 42 or 43 may be formed with an engaging head 421 or 431 at a free end of the pin to be stably engaged with a pin hole formed through each sheet 1, 2, 3.

The engaging head 421 or 431 may be formed to be slightly larger in size or diameter than the diameter of the pin in order to be stably engaged with any pin hole formed in the sheet 1, 2, or 3.

However, the pin or engaging head is not limited for the shape, structure or materials. For simple production of the pin, it may be formed by plastic molding process.

If the assembled article is a fixed article without being dismantled, the engaging head 421 or 431 may be formed as a ratchet tooth to be stably locked in a pin hole formed in the sheet.

The front sheet 1 and the rear sheet 2 are each formed with a plurality of pin holes 11 or 21 along a periphery or circumferential edge portion of each sheet 1 or 2. And the partitioning sheet 3 is also formed with as a plurality of pin holes 31 respectively along two opposite side edge portions 30, 30 of the partitioning sheet 3. Therefore, each coupling 4 may have its pins respectively coupled to the pin holes formed in the three sheets 1, 2, 3 for assembling an article.

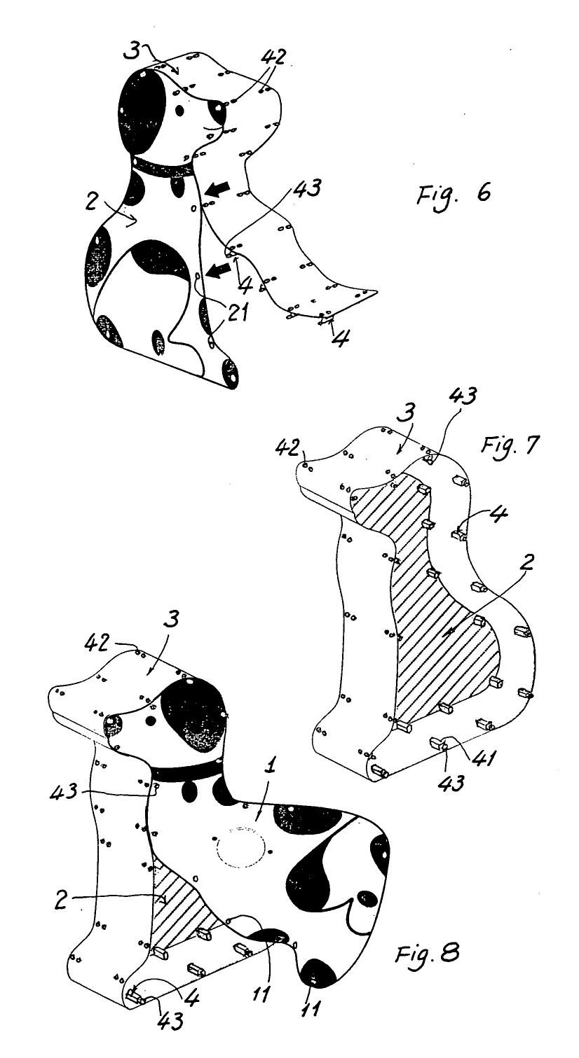

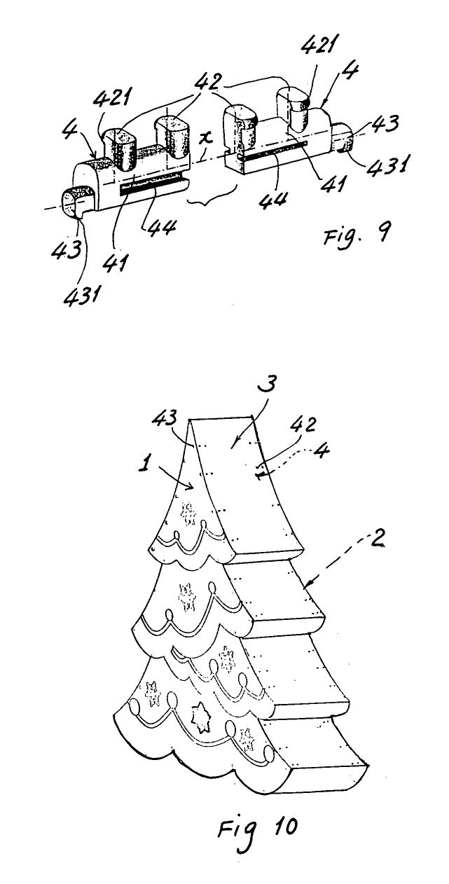

As shown in the drawing figures, the partitioning sheet 3 includes a plurality of pair of normal-pin holes 31 respectively formed in opposite side edge portions 30 of the partitioning sheet 3, each pair of normal-pin holes 31 being projectively aligned to be perpendicular to each side edge of the partitioning sheet 3 to be respectively engaged with each pair of normal pins 42 formed on each coupling 4 especially as shown in FIGS. 4, 5 and 2 so that each coupling 4 may be subsequently fastened to the partitioning sheet 3 as shown in FIG. 2. By the way, the partitioning sheet 3 may be “pre-formed” with the couplings 4 to protrude each parallel pin 43 either forwardly or rearwardly (FIG. 2) ready for engagement with a corresponding pin hole 11 formed in the frontset 1 or for engagement with a corresponding pin hole 21 formed in the rear sheet 2 to thereby integrate the assembled article such as the dog-shaped article by the steps as shown in FIGS. 2˜8.

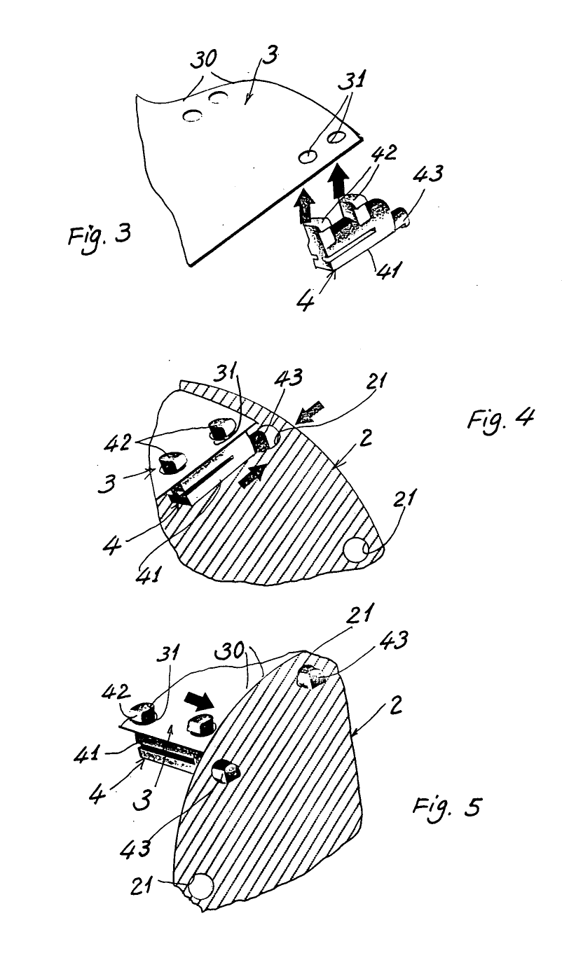

The two pins 42 provided on the coupling 4 may prevent from free rotation when fastening each coupling 4 on the partitioning sheet 3 as shown in FIG. 3.

If the normal pin 42 is formed as polygonal to be engaged with a corresponding polygonal pin hole 31 formed in the sheet 3, the normal pin 42 may be a single pin and the pin hole in the sheet 3 may then be a single pin hole for simplifying the assembly and decreasing the production cost accordingly.

In FIG. 9, the coupling 4 further includes at least a recess 44 recessed in the bolt 41 for engaging a reinforcing link member 40 which will be further described in detail hereinafter.

The article as shown in FIG. 1˜8 is a dog-shaped decorative article which includes a front sheet 1, a rear sheet 2 and a partitioning sheet 3 fastened together to form the assembled article. Originally, there are three flat sheets 1, 2, 3 of knockdown form. The partitioning sheet 3 is provided to link the front sheet 1 with the rear sheet 2 by the couplings 4. Therefore, the present invention provides an article device which can be quickly assembled from its knockdown elements, namely, the three sheets 1, 2, and 3 which can be folded, overlapped or stacked (before being assembled) for saving its volume for a convenient handling or storage and for greatly decreasing the handling, shipping or transportation cost. Upon assembly of the sheets 1, 2 and 3, a three-dimensional article can be quickly formed.

The knockdown articles may include a decorative device, a seasonal celebrating items, a lamp shade, a lighting fixture, a toy, a gift box, or any other items which may be collapsed, folded, assembled or detached immediately.

As shown in FIGS. 10˜14, a Christmas three may be made in accordance with the present invention, in which a partitioning sheet 3 is also provided to link the front sheet 1 and the rear sheet 2 with one another to form a Christmas-tree shaped decorative article which includes three knockdown sheets 1, 2, and 3 as aforementioned.

Since the width W between the front and rear sheets 1, 2 is widened, a reinforcing linking member 40 (FIGS. 13˜14) is provided to couple two couplings 4, 4 respectively connecting the partitioning sheet 3 with the front and rear sheets 1, 2. That is to say that the reinforcing link member 40 is linked between the two couplings disposed on opposite side edge portions of the partitioning sheet 3 to serve as a “beam” under the roof (the partitioning sheet 3) for reinforcing the partitioning sheet 3 and also for enhancing the strength and stability of the front sheet 1 and the rear sheet 2 as fastened with the partitioning sheet 3 for forming a stable strong decorative device accordingly.

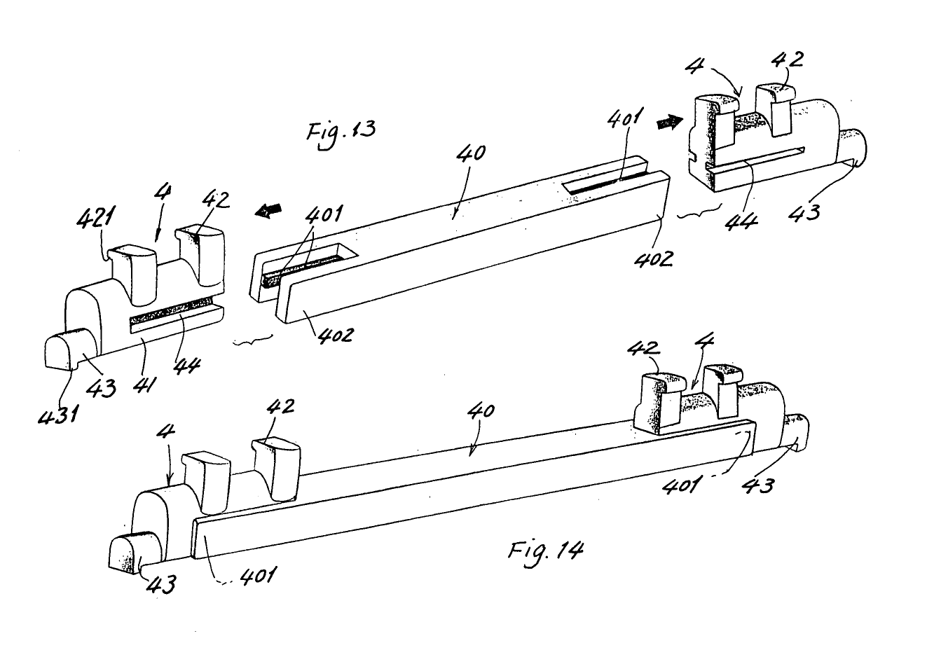

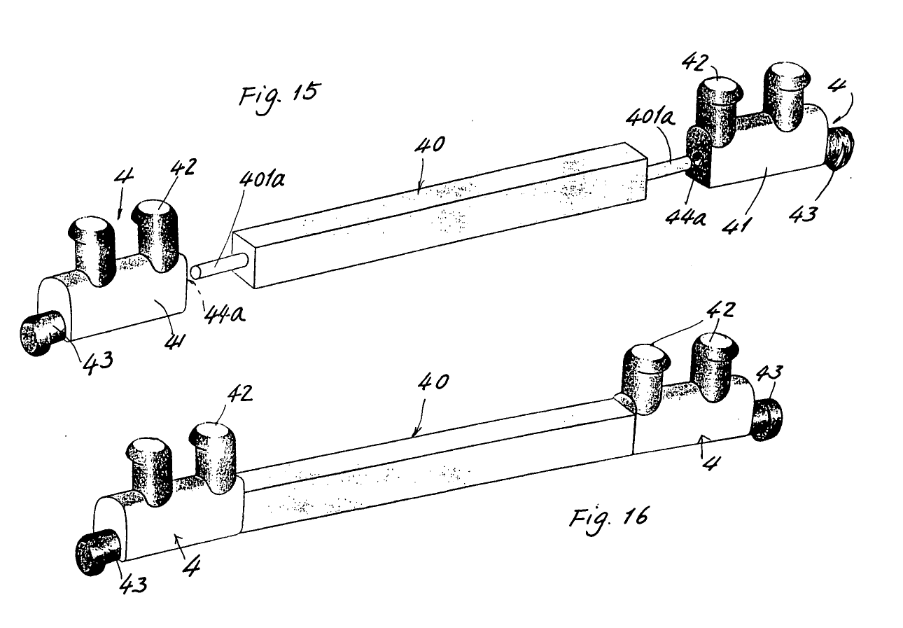

The reinforcing linking member 40 as shown in FIGS. 13, 14 includes two male connectors 401 on opposite ends of the linking member 40, each male connector 401 engaged with a female connector 44 formed in each coupling 4 (as modified from that as shown in FIG. 9) so that each coupling 4 will be engaged with or fastened to the linking member 40 as shown in FIG. 14.

The male connector 401 may be a pair of projections formed on a U-shaped end portion 402 (FIG. 13) of the linking member 40 to be engaged with a pair of recesses 44 recessed in an inner end of the coupling 4 for fastening the coupling 4 to an end of the linking member 40, whereby two couplings 4 may be fastened to opposite ends of the linking member 40 as shown in FIG. 14.

As shown in FIGS. 15, 16, the male connector 401a is modified to be a pivot (FIG. 15) to be engaged with a female connector 44a now modified to be a pivot hole to thereby fasten the two couplings 4, 4 on opposite ends of the linking member 40 as shown in FIG. 16.

As shown in FIGS. 17˜20, a pumpkin-shaped knockdown article is made in accordance with the present invention, which includes: a plurality of arcuate sheet members 1a, 1b, 1c, etc., which may be assembled to form a spherical-shaped or cylindrical article as coupled by the couplings 4 as illustrated in FIG. 9.

By the way, a pumpkin-shaped or ball-shaped article may be obtained in accordance with the present invention. A ferrule 5 (FIG. 20) may be provided for fastening the plural sheet members 1a, 1b, 1c.

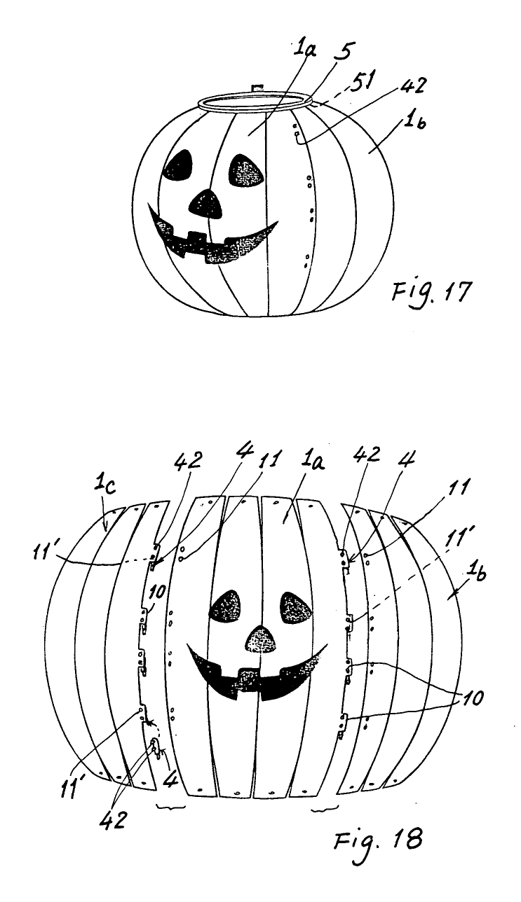

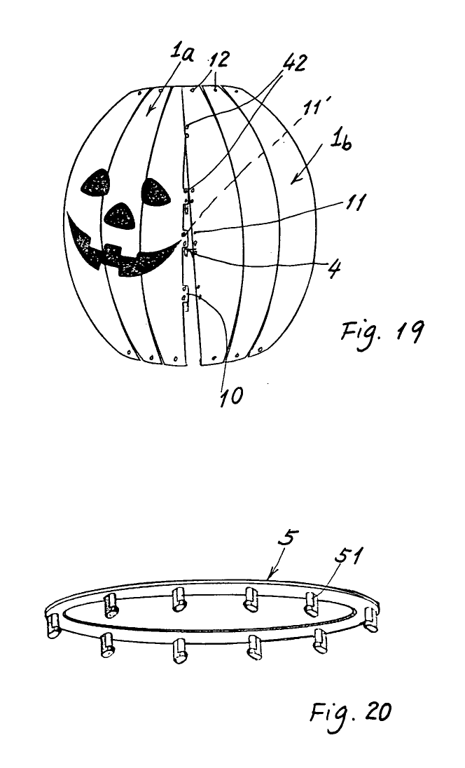

As shown in FIGS. 18, 19, a side arcuate sheet member 1c includes a plurality of flaps 10 formed on a side edge portion of the arcuate sheet member 1c, having a pair of flap pin holes 11′ formed in each flap 10 to be engaged with two normal pins 42 formed on each coupling 4 (FIG. 9). Then, a middle arcuate sheet member la has its side (left side) edge portion formed with a plurality of pairs of pin holes 11, each pair of pin holes 11 adapted to be engaged with the two normal pins 42 already engaged with and protruding outwardly from the two flap pin holes 11′ formed in each flap 10 of the side arcuate sheet member 1c. Therefore, the side sheet member 1c will be coupled to the middle sheet member 1a.

Similarly, another side sheet member 1b has its left side edge portion formed with a plurality of pairs of pin holes 11 each pair of pin holes engaged with each pair of normal pins 42 of each coupling 4 already engaged with and protruding outwardly from two flap pin holes 11′ formed in each flap 10 formed on the side (right side) edge portion of the middle sheet member 1a, thereby coupling and assembling the plural sheet members to form a generally spherical-shaped article (FIG. 19). A ferrule 5 has a plurality of teeth 51 formed on the ferrule 5 to be engaged with a plurality of tooth holes 12 circularly formed in a periphery of the spherical-shaped article assembled by the plurality of arcuate sheet members 1a, 1b, 1c, thereby stably assembling the spherical-shaped or pumpkin-shaped article as shown in FIG. 17.

Accordingly, one arcuate sheet member (or the left sheet member) may have its right side edge portion formed with a plurality of flaps 10, each flap 10 having a pair of flap pin holes 11′ formed in each flap 10 to be engaged with a pair of pins 42 of a coupling 4; and the other neighboring arcuate sheet member (or the right sheet member) may have its left side edge portion formed with a plurality of pairs of pin holes, each pair of pin holes 11 of the right sheet member engaged with one pair of the pins 42 already engaged with and protruding outwardly from the pair of flap pin holes 11′ of the left sheet member to thereby couple and assemble one pair of two neighboring arcuate sheet members; and upon concentric fastening of a plurality of pairs of two neighboring arcuate sheet members, a spherical-shaped article will be assembled as shown in FIG. 17.

The ferrule 5 and teeth 51 as shown in FIG. 20 may otherwise be further modified and changed without being limited in the present invention.

Each coupling 4 may be horizontally positioned to have its two normal pins 42 to be respectively engaged with two corresponding pin holes formed in two neighboring sheet members to thereby assemble the two neighboring sheet members.

Other shapes, designs or modifications for the assembled knockdown article or for the couplings 4 and the ferrule 5 may be made and not limited in this invention.

I claim:

1. A knockdown article comprising:
a plurality of sheets, which are foldably integrated to be an assembled article by a plurality of couplings, each said coupling having a first pin engaged with a first pin hole formed in a first sheet and having a second pin of said coupling engaged with a second pin hole formed in a second sheet in order to link said first sheet with said second sheet to thereby assemble said first sheet and said second sheet to be an assembled article including at least said first sheet and said second sheet.

2. A knockdown article according to claim 1, wherein said article includes: a front sheet, a rear sheet juxtatpositioned to the front sheet, and a partitioning sheet spaced in between the front sheet and the rear sheet; all said sheets being foldably assembled by a plurality of couplings.

3. An article according to claim 2, wherein each said coupling includes: a bolt defining a longitudinal axis at a longitudinal center thereof, two normal pins protruding outwardly from the bolt to be perpendicular to the longitudinal axis to be engaged with two normal-pin holes formed in said partitioning sheet, and a parallel pin protruding sidewardly from the bolt to be parallel to the longitudinal axis of the bolt to be engaged with each pin hole formed in either said front or rear sheet; said two normal pins projectively aligned to be parallel to the longitudinal axis of the bolt.

4. An article according to claim 3, wherein each said pin is formed with an engaging head at a free end of the pin to be stably engaged with a pin hole formed through each said sheet.

5. An article according to claim 4, wherein said engaging head is formed to be slightly larger in size or diameter than the that of the pin in order to be stably engaged with any pin hole formed in the sheet.

6. An article according to claim 4, wherein said engaging head is formed as a ratchet to be stably locked in a pin hole formed in the sheet.

7. An article according to claim 2, wherein said front sheet and said rear sheet are each formed with a plurality of pin holes along a periphery or circumferential edge portion of each said front or rear sheet; and said partitioning sheet formed with a plurality of pin holes respectively along two opposite side edge portions of the partitioning sheet corresponding to said pin holes formed in said front and rear sheet to allow each said coupling to having a plurality of pins on said coupling to be engaged with the pin holes formed in said front, rear and partitioning sheets for assembling said sheets to be an article.

8. An article according to claim 2, wherein said partitioning sheet includes a plurality of pairs of normal-pin holes respectively formed in opposite side edge portions of the partitioning sheet, each pair of said normal-pin holes being projectively aligned to be perpendicular to each side edge of the partitioning sheet to be respectively engaged with each pair of normal pins formed on each said coupling so that each said coupling is subsequently fastened to the partitioning sheet to protrude one said parallel pin formed on one said coupling forwardly for engagement with a corresponding pin hole formed in the front sheet or to protrude another parallel pin formed on another coupling rearwardly for engagement with a corresponding pin hole formed in the rear sheet to thereby integrate the assembled article.

9. An article according to claim 3, wherein each said coupling is further formed with a female connector in said coupling to be engaged with a reinforcing linking member, which is provided to be linked in between two couplings respectively fastened to opposite side edge portions of said partitioning sheet.

10. An article according to claim 9, wherein said reinforcing linking member includes two male connectors formed on opposite ends of the linking member, each said male connector of said linking member engaged with a female connector formed in each said coupling so that each said coupling is engaged with or fastened to said linking member.

11. An article according to claim 10, wherein said male connector includes a pair of projections formed on a U-shaped end portion of the linking member to be engaged with a pair of recesses recessed in an inner end of the coupling for fastening the coupling to an end of the linking member, whereby two said couplings are fastened to opposite ends of the linking member.

12. An article according to claim 10, wherein said male connector on said linking member is a pivot to be engaged with a pivot hole which is a female connector formed in said coupling to thereby fasten the two couplings on opposite ends of the linking member.

13. A knockdown article comparing a plurality of arcuate sheet members which are integrated to form a spherical-shaped or cylindrical assembled article, every two neighboring arcuate sheet members consisting of a left-side arcuate sheet member and a right-side arcuate sheet member and linked by a plurality of couplings, each said coupling including two pins formed on said coupling to be respectively engaged with two pin holes respectively formed in said two neighboring arcuate sheet members for linking said two neighboring sheet members in order to integrate said article as spherically or cylindrically shaped.

14. An article according to claim 13, wherein all said arucate sheet members are integrated by at least a ferrule having a plurality of teeth formed on the ferrule to be engaged with a plurality of tooth holes circularly formed in a periphery of the spherical-shaped article assembled by the plurality of arcuate sheet members.

15. An article according to claim 13, wherein each said left-side arcuate sheet member has its right side edge portion formed with a plurality of flaps, each said flap having a pair of flap pin holes formed in each said flap to be engaged with a pair of pins formed on said coupling; and each said right-side arcuate sheet member having its left side edge portion formed with a plurality of pairs of pin holes, each pair of pin holes engaged with one pair of the pins already engaged with and protruding outwardly from the pair of flap pin holes formed in said left-side arcuate sheet member to thereby couple and assemble said left-side and right-side sheet members neighboring each other.
